(19) United States
(12) Patent Application Publication
(10) Pub. No.: US 2013/0117292 A1
(43) Pub. Date: May 9, 2013

(54) CONNECTION OF USERS BY GEOLOCATION

(71) Applicants: Elinor Axelrod, Tel Aviv (IL); Ronen Boazi, Binyamina (IL)

(72) Inventors: Elinor Axelrod, Tel Aviv (IL); Ronen Boazi, Binyamina (IL)

(73) Assignee: MICROSOFT CORPORATION, Redmond, WA (US)

(21) Appl. No.: 13/293,093

(22) Filed: Nov. 9, 2011

(51) Int. Cl. G06F 17/30

(52) U.S. Cl. 707/758; 707/E17.018; 707/E17.014

(57) ABSTRACT

Architecture that enables discovery and communications between users that have common interests (e.g., visited the same place). For example, when users arrive at a geographic location (e.g., a business) at various times, the users are registered (automatically or manually) via a location-based service. A user can register at the location so other users may discover the user by association to the same location and according to concurrent (all or a portion of overlap of time) visitation. The registration process creates visit information of a visiting user, and a history component stores the visit information and provides access to the visit information according to user access preferences. The architecture further enables searches to be performed over the visit information by users to find other users who visited the location at the same time, to find potential new friends, and also suggest other users who match the user profile preferences.

### BACKGROUND

The advent of the Internet has spawned a wide variety of data collection capabilities for myriad different purposes. However, the ability to use this information to bring people together such as for conferencing and social gatherings, for example, remains a challenge.

### SUMMARY

The following presents a simplified summary in order to provide a basic understanding of some novel embodiments described herein. This summary is not an extensive overview, and it is not intended to identify key/critical elements or to delineate the scope thereof Its sole purpose is to present some concepts in a simplified form as a prelude to the more detailed description that is presented later.

The disclosed architecture enables the discovery and establishment of communications between users who have shared interests, as indicated as having been at the same place (which includes being at the same place during the same period of time). The shared interest can be indicated by attending the same place and/or attending the same activity, for example. When users arrive at a geographic location (e.g., a business) at various times, the users are registered (automatically or manually) via a location-based service (also referred to as a check-in service). A user can register at the location so other users may discover the user by association to the same location. A preference can be made to filter (or restrict) the visit information to other users who have visit information that is defined as concurrent (all or a portion of overlap of time between one user and one or more other users). The registration process creates visit information of a visiting user, and a history component stores the visit information and provides access to the visit information according to user access preferences. The architecture further enables searches to be performed over the visit information by users to find other users who visited the location at the same time, to find potential new connections (e.g., friends), and also suggest other users who match the user profile preferences.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative system that employs a communications component that utilizes the concurrency to connect two users.

FIG. 3 illustrates a diagram of registering users to a place.

FIG. 4 illustrates a flow diagram for searching for users who have concurrency in a visit to a place.

FIG. 5 illustrates a data store management system that manages storage and access of the location history.

FIG. 6 illustrates a method in accordance with the disclosed architecture.

FIG. 7 illustrates further aspects of the method of FIG. 6.

FIG. 8 illustrates an alternative method in accordance with the disclosed architecture.

FIG. 9 illustrates further aspects of the method of FIG. 8.

FIG. 10 illustrates a block diagram of a computing system that executes connecting people who have visited the same place in accordance with the disclosed architecture.

### DETAILED DESCRIPTION

The disclosed location-based architecture enables the discovery and communications between users who have shared interests, as detected and indicated by visitation of the same geographic location. The user can register in a location so others can discover the user based on association with the location. The architecture enables searches on past locations, for example, to assist in finding potential new user connections, and can also suggest users that match user profile preferences. The architecture can utilize existing checking-in systems, thereby enhancing usage and the data stored of the checking-in user.

Visitation between at least two users can exhibit concurrency. In other words, if a first user visits a location for two hours and a second user also visits the location, but only for one hour such that the visit of the second user overlaps in time by some portion, the location-based architecture enables discovery and communication with people who have been at the same place during the same period of time.

Following is a general description of some components. On the client side, the user device facilitates registration to a location, which then enables the user to indicate the user located as certain place. This comprises checking-in (e.g., using a 3^{rd-}party check-in mechanism), and applying the user's identity to enable other users to contact the user. Another alternative is that the user can pre-register to this application and insert personal details, as well as personal preferences.

Discovery enables the user to search on the user's past locations and discover people matching the user's criteria. The user may filter the results based on his preferences, for example. The user can choose to connect with people found in the discovery phase. Management of location history enables hiding of the user's check-in from other users in the system.

A management system handles storage, search capabilities, and the application of validity properties. Storage accommodates the users along with associated checked-in locations and visibility preferences (e.g., users who have chosen to hide a certain location check-in).

Reference is now made to the drawings, wherein like reference numerals are used to refer to like elements throughout. In the following description, for purposes of explanation, numerous specific details are set forth in order to provide a thorough understanding thereof It may be evident, however, that the novel embodiments can be practiced without these specific details. In other instances, well known structures and devices are shown in block diagram form in order to facilitate a description thereof The intention is to cover all modifications, equivalents, and alternatives falling within the spirit and scope of the claimed subject matter.

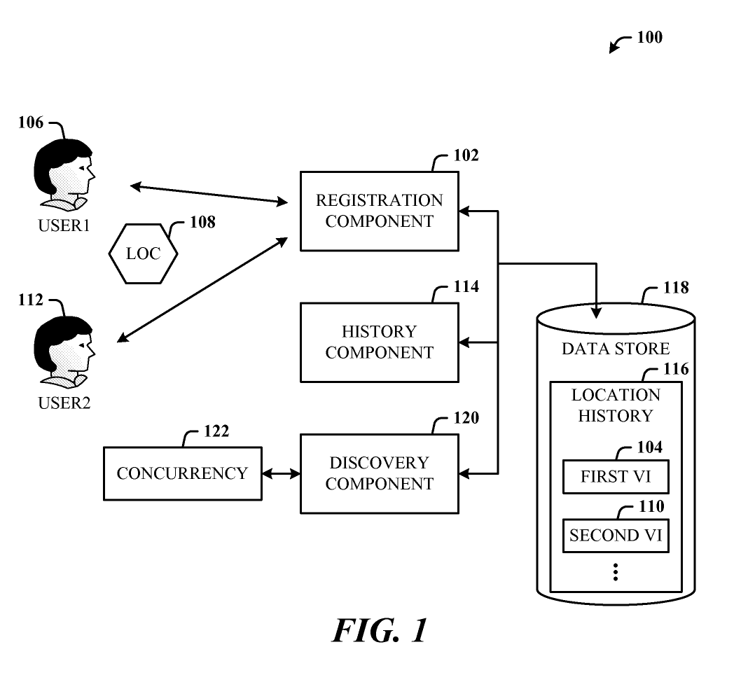

FIG. 1 illustrates a system 100 in accordance with the disclosed architecture. The system 100 includes a registration component 102 that registers first visit information 104 (denoted FIRST VI) for visit of first user 106 to a geographic location 108 and registers second visit information 110 (denoted SECOND VI) for visit of a second user 112 to the geographic location 108. (Note that the use of “first” and “second” descriptors for visit information and users is intended only to identify at least two sets of visit information and two users, and not necessarily to indicate any order or sequence. For example, it is not a requirement that first visit information 104 be registered before the second visit information 110.) The system 100 can further include a history component 114 that stores the first visit information 104 of the first user 106 and the second visit information 110 of the second user 112 as location history 116. The location history 116 is shown as being stored in a data store 118. A discovery component 120 enables search of the location history 116 to discover a common interest between the first user and the second user based on the first visit information 104 and the second visit information 110. The common interest can be derived based on both users having visited the same place at separate times and/or at the same time (e.g., concurrency 122).

The discovery component 120 facilitates the discovery of the concurrency 122 in the common interest, which can be computed as an overlapping span of time of the first visit information 104 and the second visit information 110. The common interest can be defined (e.g., the same, differently) for different geographic locations. The registration component 102 automatically creates the first and second visit information (104 and 110) via a location-based service (a service that obtains and utilizes the geolocation information of a device such as a mobile phone). The registration component 102 can register the first visit information 104 based on a user profile of the first user 106.

The first visit information 104 can include identity information (e.g., name, email address, network address, etc.) of the first user 106 for use in communicating with the first user 106. The history component 114 hides visit information of a user (e.g., second visit information 110) to prevent discovery by another user (e.g., the first user 106). The history component 114 applies an aging criterion (e.g., visit information for a given venue is stored no longer than two days) to specific categories (e.g., restaurant, theater, etc.) of geographic location to age out visit information of users for the categories.

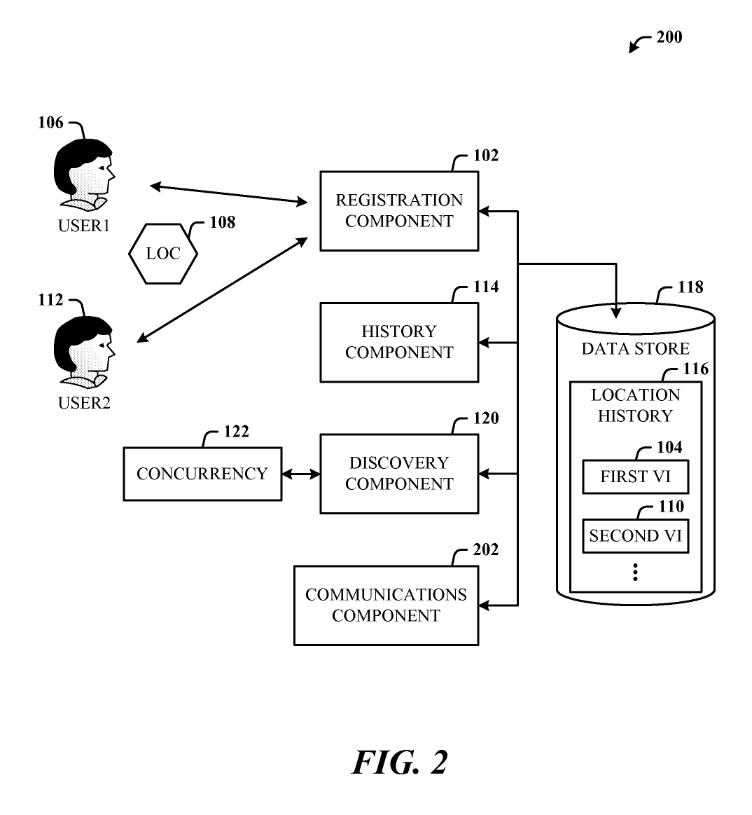

FIG. 2 illustrates an alternative system 200 that employs a communications component 202 that utilizes the concurrency to connect two users. In other words, the communications component 202 enables the first user 106 and the second user 112 to communicate based on the common interest in the first visit information 104 and the second visit information 110.

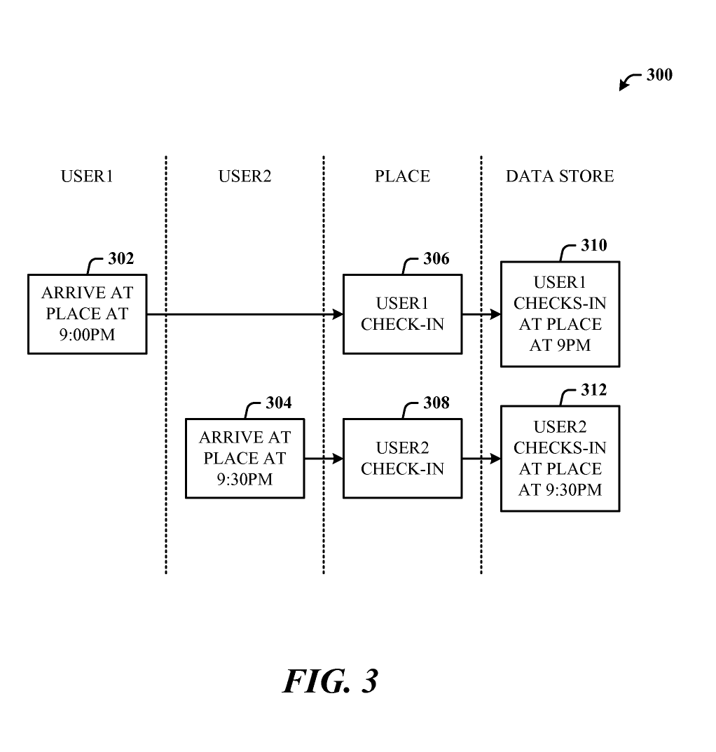

FIG. 3 illustrates a diagram 300 of registering users to a place. At 302, the first user arrives at the place at 9:00 PM. At 304, the second user arrives at the place at 9:30 PM. At 306, the first user is registered (also referred to as check-in), and at 308, the second user is registered. Registration of a user involves determining the geolocation of the user relative to the geolocation of the place. This can be accomplished by comparing global positioning system (GPS) coordinates of the user (e.g., mobile phone or other type of mobile device) and the place. If there is sufficient similarity between the user geolocation information and the place geolocation information, the user is considered to be at the place.

At 310, the data store stores the first visit information for the first user, which can include the identity of the first user, the place identification, and the time of the check-in of the first user, for example. Similarly, at 312, the data store stores the second visit information for the second user, which can include the identity of the second user, the place identification, and the time of the check-in of the second user, for example. Thus, the location history can include relationships that relate the identity of the first user, the place identification, and the time of the check-in of the first user, and relate the identity of the second user, the place identification, and the time of the check-in of the second user.

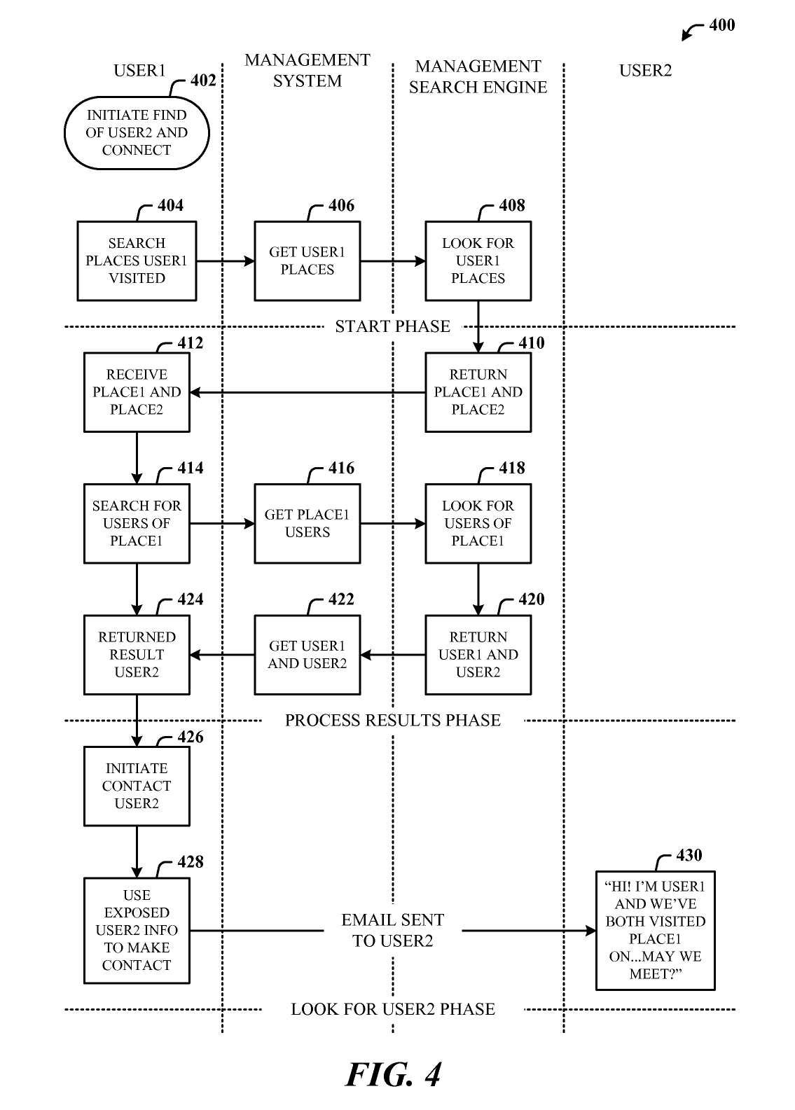

FIG. 4 illustrates a flow diagram 400 for searching for users who have concurrency in a visit to a place. Beginning in a start phase, at 402, User1 wants to find another user (User2) who has visited Place1 and then connect to that user (User2). At 404, User1 initiates as search of places User1 has visited. At 406, the search request is sent to the data store management system, which sends a get of User1 places to the search engine. At 408, the search engine then looks for places visited by User1.

Leaving the start phase and moving to a process results phase, at 410, the search engine returns Place1 and Place2 as places User1 has visited. At 412, User1 receives the places information from the search engine. At 414, User1 searches for users of Place1. At 416, the search request is sent to the management system, which then sends a get of the Place users to the search engine. At 418, the search engine looks for users of Place1. At 420, the search engine returns User1 and User2 as users who have visited Place1. At 422, the management system receives the user information from the search engine. At 424, User1 receives a result that indicates User2 concurrently visited Place1.

Leaving the results phase, and entering a user phase, at 426, User1 initiates contact to User2. At 428, exposed User2 information is used to make contact to User2. User1 then sends an introductory email (or other type of communication) to User2 (e.g., “Hi! I'm User1 and we've both visited Place1 on . . . may we meet?”).

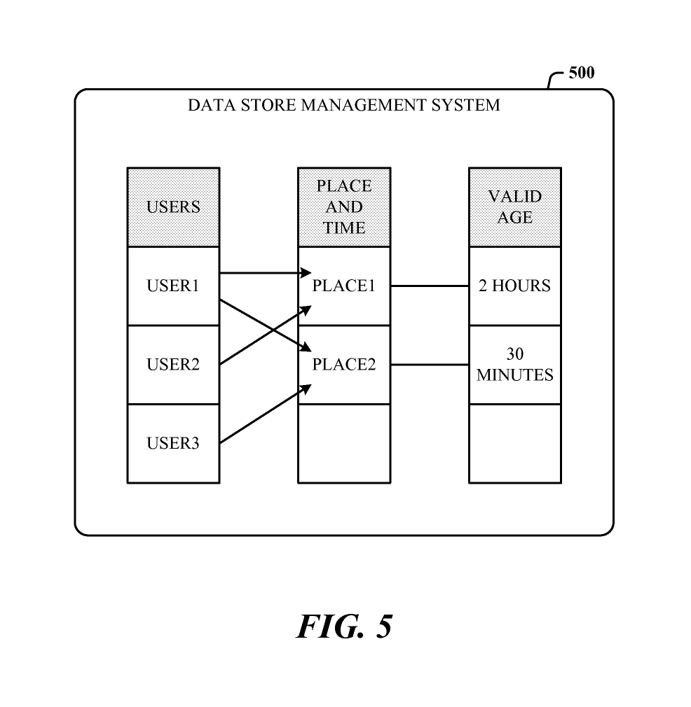

FIG. 5 illustrates a data store management system 500 (e.g., of the data store 118 of FIG. 1) that manages storage and access of the location history. The management system 500 handles storage, search capabilities, and the application of validity properties. Storage accommodates the users along with associated checked-in locations and visibility preferences (e.g., users who have chosen to hide a certain location check-in).

With respect to search capabilities, users can be found that were at a given location at a given time (e.g., using the place the user has checked-in to). The system can infer the period of time, given the check-in time and the location's validity age property. Searching also finds all check-ins the user has made. Optionally, the system can suggest connections for those users who have defined their personal preferences. The system finds and suggests people matching some of the preferences with which to connect.

The management system 500 also applies social validity aging per each checked-in location (for each location stored, the system attach its valid age). This can be performed using search engines and the location information, along with pre-defined aging per certain venues. For instance, a restaurant can have a validity age such as two hours, whereas a metro station can have aging of a maximum one hour.

In this particular implementation, the store management system 500 relates users to time and place, and to a valid age. For example, a User1 arrives as a Place1 with a valid age of two hours. The valid age is the time span over which User1 is likely to be at the location, Place1. For example, if Place1 is an upscale restaurant, the time spent (the valid age) for a person dining at that type of restaurant can be set for two hours, before paying the check and then departing. If the eating establishment is a diner, then the valid age can be set to one hour, as people typically can eat and depart in about one hour. In this example, the store management system 500 registers User1 to Place1 at an arrival time for a visitation span (valid age) of two hours from the arrival time. Additionally, registration occurs for User1 at Place2 at an arrival time for a visitation span set for thirty minutes from the arrival time. Still further, the store management system 500 registers User2 at Place1 at an arrival time for a visitation span (valid age) of two hours from the arrival time. A User3 is registered to Place2 at an arrival time and for a visitation span of thirty minutes from the arrival time.

This location history then becomes searchable for concurrency. In other words, if User1 searches for other users who have visited Place1 at some point in time when User1 visited Place1, the search will return User2, provided that User2 was visiting Place1 within the 2-hour visitation span of the arrival of User1 at Place1. If User1 searches for other users who have visited Place2 at some point in time when User1 visited Place2, the search will return User3, provided that User3 was visiting Place2 within the 30-minute visitation span of the arrival of User1 at Place2.

It is within contemplation of the disclosed architecture that searches can be performed based on different parameters such as simply all two-hour visitation spans (valid ages) for a given user (e.g., User1) to develop trends of user activity at specific categories of locations (e.g. restaurants), for example.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

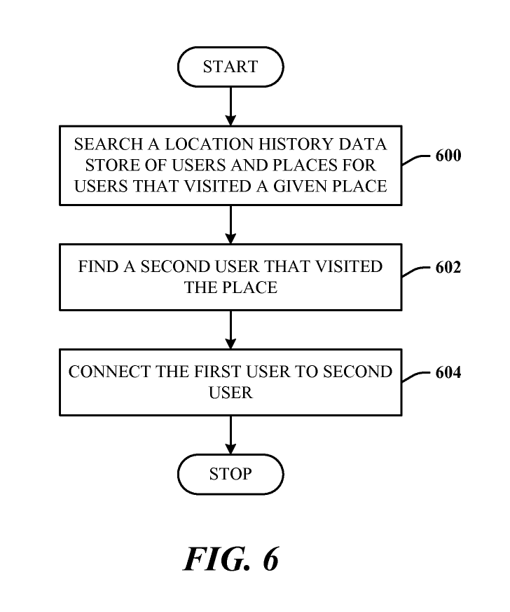

FIG. 6 illustrates a method in accordance with the disclosed architecture. At 600, a location history data store of users and places is searched for users that visited a given place. Note that storage can be performed for a wide variety of information from which to search and discover commonalty such as in common interests. For example, other than the place, a common interest may further include the type of credit card used to complete payment of a transaction at the place, the item purchased, the time of day the item was purchased, the type of food ordered, etc. At 602, a second user is found that visited the place. At 604, the first user is connected to the second user.

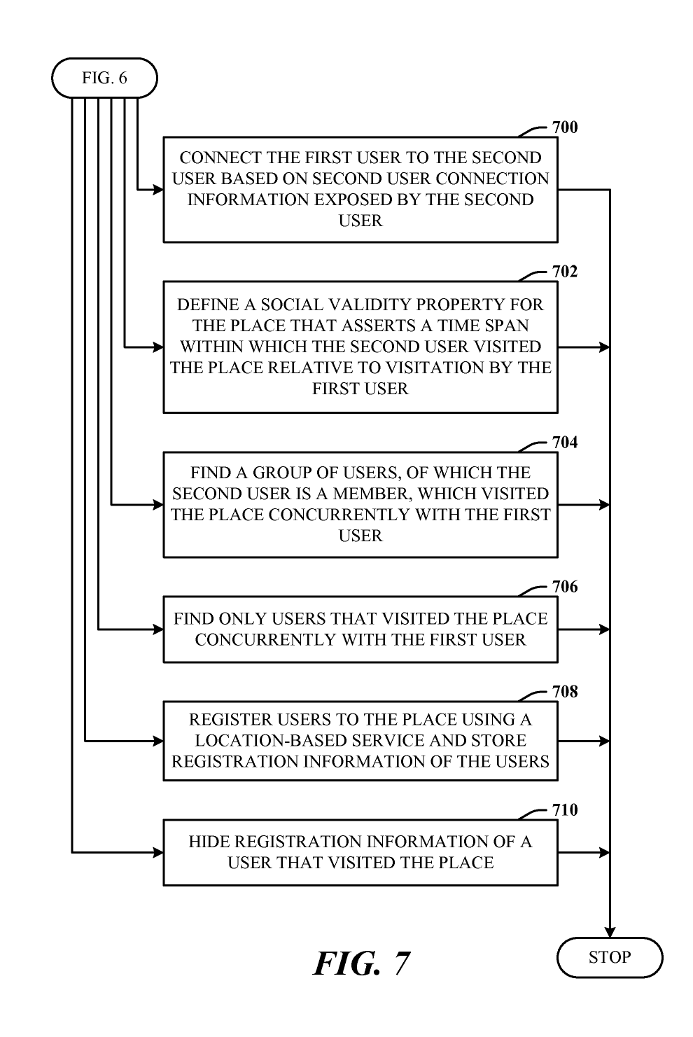

FIG. 7 illustrates further aspects of the method of FIG. 6. Note that the flow indicates that each block can represent a step that can be included, separately or in combination with other blocks, as additional aspects of the method represented by the flow chart of FIG. 6. At 700, the first user is connected to the second user based on second user connection information exposed by the second user. At 702, a social validity property is defined for the place that asserts a time span within which the second user visited the place relative to visitation by the first user. At 704, a group of users, of which the second user is a member, is found which visited the place concurrently with the first user. At 706, only users are found that visited the place concurrently with the first user. At 708, users are registered to the place using a location-based service and storing registration information of the users. At 710, registration information of a user that visited the place is hidden.

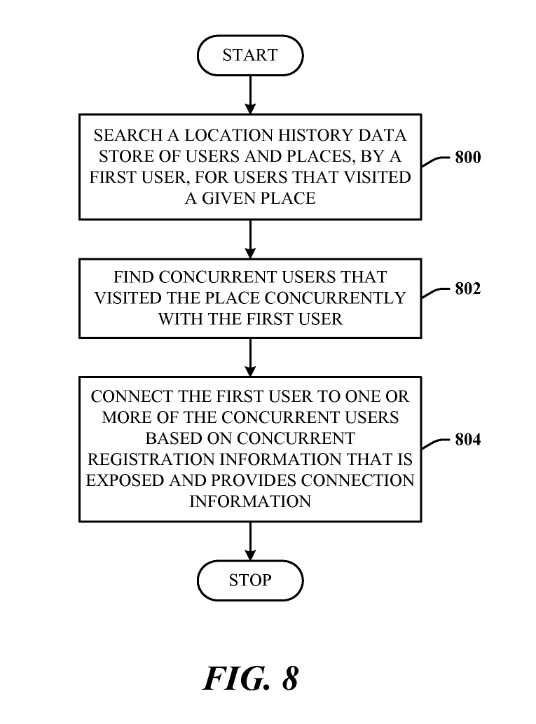

FIG. 8 illustrates an alternative method in accordance with the disclosed architecture. At 800, a location history data store of users and places is searched by a first user for users that visited a given place. At 802, concurrent users that visited the place concurrently with the first user are found. At 804, the first user is connected to one or more of the concurrent users based on concurrent registration information that is exposed and provides connection information.

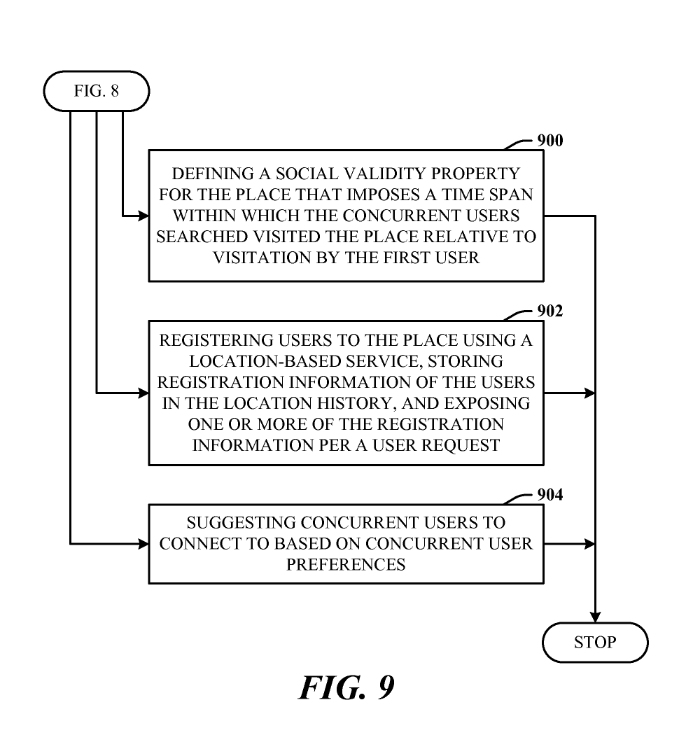

FIG. 9 illustrates further aspects of the method of FIG. 8. Note that the flow indicates that each block can represent a step that can be included, separately or in combination with other blocks, as additional aspects of the method represented by the flow chart of FIG. 8. At 900, a social validity property is defined for the place that imposes a time span within which the concurrent users searched visited the place relative to visitation by the first user. At 902, users are registered to the place using a location-based service, registration information of the users is stored in the location history, and one or more of the registration information is exposed per a user request. At 904, concurrent users are suggested (to the first user) to connect to based on concurrent user preferences.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

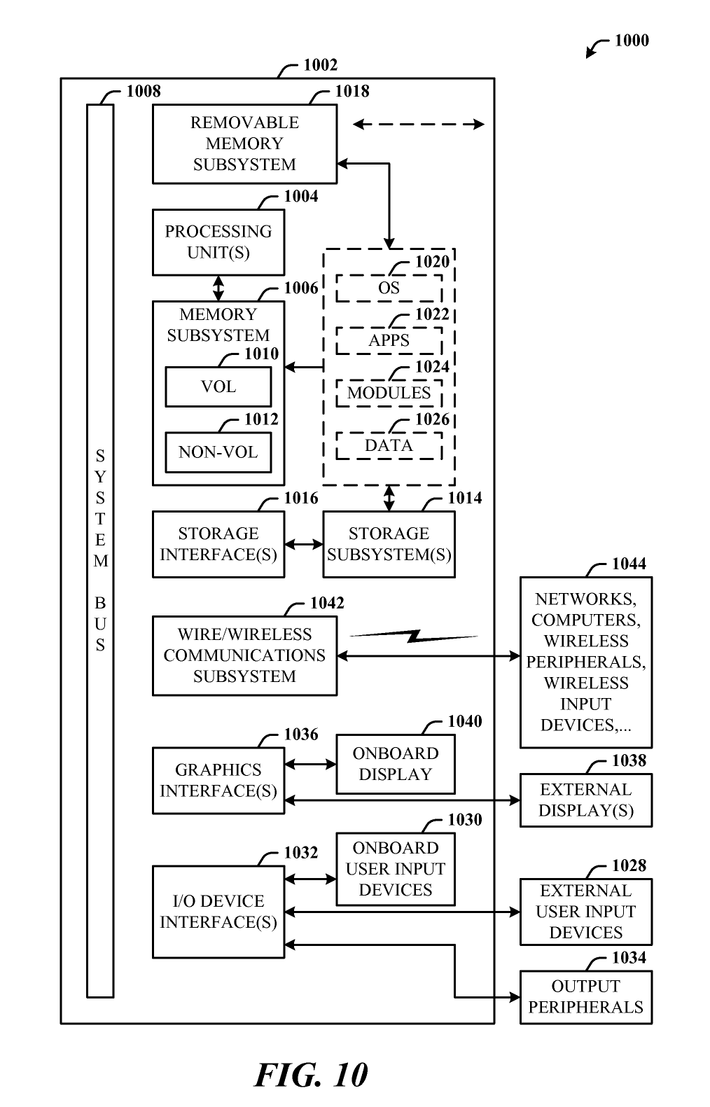

Referring now to FIG. 10, there is illustrated a block diagram of a computing system 1000 that executes connecting people who have visited the same place in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 10 and the following description are intended to provide a brief, general description of the suitable computing system 1000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1000 for implementing various aspects includes the computer 1002 having processing unit(s) 1004, a computer-readable storage such as a system memory 1006, and a system bus 1008. The processing unit(s) 1004 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1006 can include computer-readable storage (physical storage media) such as a volatile (VOL) memory 1010 (e.g., random access memory (RAM)) and non-volatile memory (NON-VOL) 1012 (e.g., ROM, EPROM, EEPROM, etc.). A basic input/output system (BIOS) can be stored in the non-volatile memory 1012, and includes the basic routines that facilitate the communication of data and signals between components within the computer 1002, such as during startup. The volatile memory 1010 can also include a high-speed RAM such as static RAM for caching data.

The system bus 1008 provides an interface for system components including, but not limited to, the system memory 1006 to the processing unit(s) 1004. The system bus 1008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1002 further includes machine readable storage subsystem(s) 1014 and storage interface(s) 1016 for interfacing the storage subsystem(s) 1014 to the system bus 1008 and other desired computer components. The storage subsystem(s) 1014 (physical storage media) can include one or more of a hard disk drive (HDD), a magnetic floppy disk drive (FDD), and/or optical disk storage drive (e.g., a CD-ROM drive DVD drive), for example. The storage interface(s) 1016 can include interface technologies such as EIDE, ATA, SATA, and IEEE 1394, for example.

One or more programs and data can be stored in the memory subsystem 1006, a machine readable and removable memory subsystem 1018 (e.g., flash drive form factor technology), and/or the storage subsystem(s) 1014 (e.g., optical, magnetic, solid state), including an operating system 1020, one or more application programs 1022, other program modules 1024, and program data 1026.

The operating system 1020, one or more application programs 1022, other program modules 1024, and/or program data 1026 can include entities and components of the system 100 of FIG. 1, entities and components of the system 200 of FIG. 2, entities and flow of the diagram 300 of FIG. 3, entities and flow of the diagram 400 of FIG. 4, entities and components of the system 500 of FIG. 5, and the methods represented by the flowcharts of FIGS. 6-9, for example.

Generally, programs include routines, methods, data structures, other software components, etc., that perform particular tasks or implement particular abstract data types. All or portions of the operating system 1020, applications 1022, modules 1024, and/or data 1026 can also be cached in memory such as the volatile memory 1010, for example. It is to be appreciated that the disclosed architecture can be implemented with various commercially available operating systems or combinations of operating systems (e.g., as virtual machines).

The storage subsystem(s) 1014 and memory subsystems (1006 and 1018) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1002 and includes volatile and non-volatile internal and/or external media that is removable or non-removable. For the computer 1002, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1002, programs, and data using external user input devices 1028 such as a keyboard and a mouse. Other external user input devices 1028 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1002, programs, and data using onboard user input devices 1030 such a touchpad, microphone, keyboard, etc., where the computer 1002 is a portable computer, for example. These and other input devices are connected to the processing unit(s) 1004 through input/output (I/O) device interface(s) 1032 via the system bus 1008, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1032 also facilitate the use of output peripherals 1034 such as printers, audio devices, camera devices, and so on, such as a sound card and/or onboard audio processing capability.

One or more graphics interface(s) 1036 (also commonly referred to as a graphics processing unit (GPU)) provide graphics and video signals between the computer 1002 and external display(s) 1038 (e.g., LCD, plasma) and/or onboard displays 1040 (e.g., for portable computer). The graphics interface(s) 1036 can also be manufactured as part of the computer system board.

The computer 1002 can operate in a networked environment (e.g., IP-based) using logical connections via a wired/wireless communications subsystem 1042 to one or more networks and/or other computers. The other computers can include workstations, servers, routers, personal computers, microprocessor-based entertainment appliances, peer devices or other common network nodes, and typically include many or all of the elements described relative to the computer 1002. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1002 connects to the network via a wired/wireless communication subsystem 1042 (e.g., a network interface adapter, onboard transceiver subsystem, etc.) to communicate with wired/wireless networks, wired/wireless printers, wired/wireless input devices 1044, and so on. The computer 1002 can include a modem or other means for establishing communications over the network. In a networked environment, programs and data relative to the computer 1002 can be stored in the remote memory/storage device, as is associated with a distributed system. It will be appreciated that the network connections shown are exemplary and other means of establishing a communications link between the computers can be used.

The computer 1002 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a registration component that registers first visit information for visit of first user to a geographic location and registers second visit information for visit of a second user to the geographic location;
a history component that stores the first visit information of the first user and the second visit information of the second user as location history;
a discovery component that enables search of the location history to discover a common interest between the first user and the second user based on the first visit information and the second visit information; and
a processor that executes computer-executable instructions associated with at least one of the registration component, the history component, or the discovery component.

2. The system of claim 1, wherein the discovery component facilitates the discovery of concurrency in the common interest, which is computed as an overlapping span of time of the first visit information and the second visit information.

3. The system of claim 1, wherein the common interest is defined for different geographic locations.

4. The system of claim 1, wherein the registration component automatically creates the first and second visit information via a location-based service.

5. The system of claim 1, wherein the registration component registers the first visit information based on a user profile of the first user.

6. The system of claim 1, wherein the first visit information includes identity information of the first user for use in communicating with the first user.

7. The system of claim 1, wherein the history component hides visit information of a user to prevent discovery by another user.

8. The system of claim 1, wherein the history component applies an aging criterion to specific categories of geographic location to age out visit information of users for the categories.

9. The system of claim 1, further comprising a communications component that enables the first user and the second user to communicate based on the common interest in the first and second visit information.

10. A method, comprising acts of:
searching a location history data store of users and places for users that visited a given place;
finding a second user that visited the place;
connecting the first user to the second user; and
utilizing a processor that executes instructions stored in memory to perform at least one of the acts of searching, finding, or connecting.

11. The method of claim 10, further comprising connecting the first user to the second user based on second user connection information exposed by the second user.

12. The method of claim 10, further comprising defining a social validity property for the place that asserts a time span within which the second user visited the place relative to visitation by the first user.

13. The method of claim 10, further comprising finding a group of users, of which the second user is a member, which visited the place concurrently with the first user.

14. The method of claim 10, further comprising finding only users that visited the place concurrently with the first user.

15. The method of claim 10, further comprising registering users to the place using a location-based service and storing registration information of the users.

16. The method of claim 10, further comprising hiding registration information of a user that visited the place.

17. A method, comprising acts of:
searching a location history data store of users and places, by a first user, for users that visited a given place;
finding concurrent users that visited the place concurrently with the first user;
connecting the first user to one or more of the concurrent users based on concurrent registration information that is exposed and provides connection information; and
utilizing a processor that executes instructions stored in memory to perform at least one of the acts of searching, finding, or connecting.

18. The method of claim 17, further comprising defining a social validity property for the place that imposes a time span within which the concurrent users searched visited the place relative to visitation by the first user.

19. The method of claim 17, further comprising registering users to the place using a location-based service, storing registration information of the users in the location history, and exposing one or more of the registration information per a user request.

20. The method of claim 17, further comprising suggesting concurrent users to connect to based on concurrent user preferences.
